(19) United States
(12) Patent Application Publication
(10) Pub. No.: US 2025/0299217 A1
(43) Pub. Date: Sep. 25, 2025

(54) INCENTIVE NOTIFICATION AND PURCHASE COORDINATION WITH OTHER USERS IN AN ELECTRONIC DEVICE

(71) Applicant: MOTOROLA MOBILITY LLC, WILMINGTON, DE (US)

(72) Inventors: KRISHNAN RAGHAVAN, BANGALORE (IN); VIJAYPRAKASH IDLUR, IDLUR (IN); A G PRASAD, BANGALORE (IN)

(21) Appl. No.: 18/614,692

(22) Filed: Mar. 24, 2024

(51) Int. Cl. G06Q 30/0207; G06Q 30/0601

(52) U.S. Cl. CPC G06Q 30/0213; G06Q 30/0641

(57) ABSTRACT

An electronic device, a method and a computer program product for presenting incentive alerts for an intended purchase and coordinating purchases with other users. The method includes detecting a trigger indicative of an intended purchase transaction. The method includes identifying a potential incentive applicable to the intended purchase transaction and having an incentive threshold spend amount to trigger receipt of an incentive. In response to identifying the potential incentive, the method includes presenting an incentive notification on a display. The incentive notification indicating that the potential incentive is available if the transaction total spend amount of the intended purchase transaction meets or exceeds the incentive threshold spend amount. The method includes presenting at least one user-selectable option on the display that facilitates electronic notification of and coordination with at least one potential second purchaser associated with a communicatively connected second electronic device to incorporate combined purchasing of additional items.

### BACKGROUND

### 1. Technical Field

The present disclosure generally relates to electronic devices and in particular to using electronic devices to facilitate online shopping transactions.

### 2. Description of the Related Art

Electronic devices, such as mobile phones, tablets, and laptops, are widely used for video, voice, and text communication and for data transmission. Online shopping has also become a popular use for these mobile electronic devices. Online shopping is a form of electronic commerce that allows consumers to purchase goods or services using an electronic device. Consumers can find a product of interest by visiting retailer websites or by using a search engine that displays the availability and price of a product at different merchants. The consumer can then complete the purchase of the product using their electronic device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 is an example illustration of the electronic device of FIG. 1 transmitting a request for incentive data to an application computer system and a transmitting a purchase coordination notification to a second electronic device, according to one or more embodiments;

FIGS. 3A and 3B are block diagrams of example contents of the system memory of the example electronic device of FIG. 1 configured to complete the various processes described herein, according to one or more embodiments;

FIG. 4A is an example illustration of a display of an electronic device presenting a graphical user interface GUI that includes an example shopping page to purchase at least one intended purchase item, according to one or more embodiments;

FIG. 4B is an example illustration of a display of an electronic device presenting a GUI that includes an example incentive notification to alert an electronic device user that a financial incentive is potentially available with the purchase of additional items, according to one or more embodiments;

FIG. 5 is an example illustration of a display of an electronic device presenting a GUI that includes example potential purchasers and an option to select potential purchasers to assist with completing a purchase to enable receipt of an incentive, according to one or more embodiments;

FIG. 6 is an example illustration of a display of an electronic device presenting another GUI after a response to a purchase coordination notification has been received from a second electronic device to purchase at least one additional second intended purchase item, according to one or more embodiments;

FIG. 7A is an example illustration of a display of an electronic device presenting a GUI that includes example payment options to initiate processing to complete payment for a combined purchase transaction using at least one of a default payment method, a new payment method or a second payment source, according to one or more embodiments;

FIG. 7B is an example illustration of a display of an electronic device presenting a GUI that includes example shipping options to initiate processing to provide at least one shipping address for a combined purchase transaction using at least one of a default shipping address, a potential purchaser shipping address or splitting the shipment between two or more addresses, according to one or more embodiments;

FIG. 8 depicts a flowchart of a method by which an electronic device presents an incentive notification that at least one incentive is potentially available for an intended purchase and an option to contact potential purchasers to coordinate purchases with other users in order to obtain an incentive, according to one or more embodiments;

FIG. 9 depicts a flowchart of a method by which an electronic device enables the selection of potential purchasers and coordinates purchases with other users, according to one or more embodiments; and

FIG. 10 depicts a flowchart of a method by which an electronic device enables continued shopping for at least one additional second intended purchase item, according to one or more embodiments.

### DETAILED DESCRIPTION

According to one or more aspects of the disclosure, the illustrative embodiments provide an electronic device, a method, and a computer program product for presenting incentive alerts for an intended purchase and coordinating purchases with other users via an electronic device. In a first embodiment, an electronic device includes a display, a communication system that enables the electronic device to connect to external networks and devices, and a memory having stored thereon an incentive alert and purchase coordination (IAPC) module for presenting incentive alerts for an intended purchase and coordinating purchases with other users. The electronic device includes at least one processor that is communicatively coupled to the display, the communication system, and the memory. The at least one processor executes program code of the IAPC module, and configures the electronic device to detect a trigger indicative of an intended purchase transaction having a transaction total spend amount and to identify a first potential incentive applicable to the intended purchase transaction and having a first incentive threshold spend amount to trigger receipt of a corresponding incentive. In response to identifying the first potential incentive, the at least one processor presents a first incentive notification on the display. The first incentive notification indicates that the first potential incentive is potentially available if the transaction total spend amount of the intended purchase transaction meets or exceeds the first incentive threshold spend amount. The at least one processor activates and presents at least one first user-selectable option on the display that facilitates electronic notification of and coordination with at least one potential second purchaser associated with a communicatively connected second electronic device to incorporate combined purchasing of additional items by the at least one potential second purchaser within the intended purchase transaction.

According to another embodiment, the method includes detecting, via at least one processor of an electronic device, a trigger indicative of an intended purchase transaction having a transaction total spend amount. The method includes identifying a first potential incentive applicable to the intended purchase transaction and having a first incentive threshold spend amount to trigger receipt of a corresponding incentive. In response to identifying the first potential incentive, the method includes presenting a first incentive notification on a display. The first incentive notification indicates that the first potential incentive is potentially available if the transaction total spend amount of the intended purchase transaction meets or exceeds the first incentive threshold spend amount. The method includes activating and presenting at least one first user-selectable option on the display that facilitates electronic notification of and coordination with at least one potential second purchaser associated with a communicatively connected second electronic device to incorporate combined purchasing of additional items by the at least one potential second purchaser within the intended purchase transaction.

According to an additional embodiment, a computer program product includes a computer readable storage device having stored thereon program code that, when executed by at least one processor of an electronic device having a display and a communication system, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

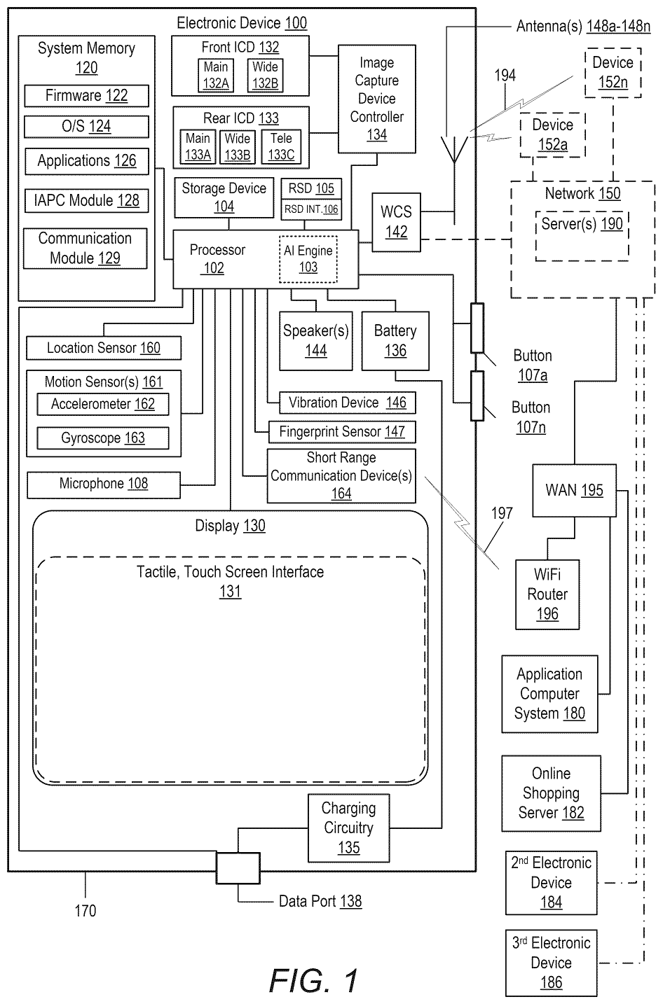

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include the capability to transmit and receive communications. Electronic device 100 includes processor 102, which is communicatively coupled to storage device 104, system memory 120, input devices, (introduced below), output devices, such as display 130, and image capture device (ICD) controller 134. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102. Processor 102 can include processor resources such as a primary processing unit (CPU) that support computing, classifying, processing and transmitting of data and information. Processor 102 can further include graphic processing units (GPU) and digital signal processors (DSP) that also support computing, classifying, processing and transmitting and receiving of data and information. Processor 102 can further include a hardware based artificial intelligence (AI) engine 103. AI engine 103 accelerates artificial intelligence, natural language processing (NLP), context evaluation (CE), and machine learning applications. AI engine 103 can also be implemented as a software module, in one embodiment.

System memory 120 may be a combination of volatile and non-volatile memory, such as random access memory (RAM) and read-only memory (ROM). System memory 120 can store program code and data associated with firmware 122, an operating system 124, applications 126, incentive alert and purchase coordination (IAPC) module 128, and communication module 129. Incentive alert and purchase coordination module 128 includes program code that is executable by processor 102 to configure electronic device 100 to track purchases and to generate a notification about potential incentives that are available to be used for the purchases. Communication module 129 includes program code that is executed by processor 102 to enable electronic device 100 to communicate with other external devices and systems.

Although depicted as being separate from applications 126, incentive alert and purchase coordination module 128, and communication module 129 may each be implemented as an application. Processor 102 loads and executes program code stored in system memory 120, including program code associated with applications 126 and program code associated with incentive alert and purchase coordination module 128, and communication module 129. When processed/executed by processor 102, the program code causes or configures electronic device 100 to provide the various functionality described herein.

In one or more embodiments, electronic device includes removable storage device (RSD) 105, which is inserted into an RSD interface 106 that is communicatively coupled via system interlink to processor 102. In one or more embodiments, RSD 105 is a non-transitory computer program product or computer readable storage device. In one or more embodiments, RSD 105 is a computer readable storage device encoded with program code and corresponding data, and RSD 105 can interchangeably be referred to as a non-transitory computer program product. RSD 105 may have a version of incentive alert and purchase coordination module 128 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Throughout the disclosure, the term image capturing device is utilized interchangeably to be synonymous with and/or refer to any one of front or rear cameras 132, 133. As illustrated, electronic device 100 includes several front cameras 132. Electronic device 100 further includes several rear cameras 133. Each front camera 132A and 132B and each rear camera 133A, 133B and 133C is communicatively coupled to ICD controller 134, which is communicatively coupled to processor 102. ICD controller 134 supports the processing of signals from front cameras 132A and 132B and rear cameras 133A, 133B, and 133C.

Electronic device 100 can further include charging circuitry 135, battery 136, and data port 138, for providing electrical power to the various electronic components of electronic device 100. Electronic device 100 further includes microphone 108, one or more output devices such as speaker 144, and one or more input buttons 107a-n. Input buttons 107a-n may provide controls for volume, power, and/or image capture devices 132, 133. Microphone 108 can also be referred to as audio input device 108. Microphone 108 can be used to provide biometric data to identify or authenticate a user. Microphone 108 and input buttons 107a-n can also be referred to generally as input devices. Speaker 144 can provide an audio alert to a user.

Electronic device 100 further includes wireless communication subsystem (WCS) 142, which is coupled to antennas 148a-148n. In one or more embodiments, WCS 142 can include a communication module with one or more baseband processors or digital signal processors, one or more modems, and a radio frequency front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150.

In one or more embodiment, wireless network 150 can include one or more servers 190 that support wireless exchange of voice, data, and video and other communication with electronic device 100. Wireless network 150 further allows electronic device 100 to communicate with application computer system 180, online shopping server 182, and second electronic device 184. Application computer system 180 and online shopping server 182 are communicatively coupled to wireless network 150 by a wide area network (WAN) 195, such as the Internet. In an embodiment, servers 190 of wireless network 150 support wireless exchange of e-mail, text, data, and other communications between electronic device 100 and application computer system 180 and online shopping server 182. In one embodiment, application computer system 180 and online shopping server 182 can provide data, information, and resources to electronic device 100 for use with applications 126, and incentive alert and purchase coordination module 128.

Second electronic device 184 and third electronic device 186 are also communicatively coupled to wireless network 150. Second electronic device 184 and third electronic device 186 can be similarly connected to wireless network 150, via one of network communication devices 152a-152n. In an embodiment, servers 190 of wireless network 150 support wireless exchange of voice, text, data, and video and other communication between electronic device 100 and second electronic device 184 and third electronic device 186. While electronic device 100 is shown in communication with two electronic devices 184, 186, electronic device 100 can be in communication with more or fewer than two electronic devices.

Electronic device 100 further includes short range communication device(s) 164. Short-range communication device 164 is a low powered transceiver that can wirelessly communicate with other devices. Short-range communication device(s) 164 can include one or more of a variety of devices supporting different corresponding wireless protocols, such as a near field communication (NFC) device, a Bluetooth device, and/or a wireless fidelity (Wi-Fi) device. Electronic device 100 can also connect wirelessly to wireless network 150 via communication signals 197 transmitted by short-range communication device(s) 164 to and from WiFi router 196, which is communicatively coupled to WAN 195, such as the Internet. Wireless network 150 is communicatively coupled to WAN 195.

Short-range communication device(s) 164 can wirelessly communicate with WiFi router 196 via communication signals 197. In one embodiment, electronic device 100 can receive Internet or Wi-Fi based calls via short-range communication device(s) 164. In one embodiment, electronic device 100 can communicate with WiFi router 196 wirelessly via short-range communication device(s) 164. In an embodiment, WCS 142, antennas 148a-148n and short-range communication device(s) 164 collectively provide communication interface(s) of electronic device 100.

Electronic device 100 further includes vibration device 146, fingerprint sensor 147, location sensor 160, and motion sensor(s) 161. Vibration device 146 can cause electronic device 100 to vibrate or shake when activated. Vibration device 146 can be activated to provide an alert or notification to a user of electronic device 100. According to one aspect of the disclosure, display 130, speakers 144, and vibration device 146 can generally and collectively be referred to as output devices. These output devices can be each utilized to present the different alerts to the user.

Fingerprint sensor 147 can be used to provide biometric data or images to identify or authenticate a user. Location sensor 160 can provide time data and location data about the physical location of electronic device 100. In one embodiment, location sensor 160 can be a global positioning system (GPS) device that uses data received from geospatial input received from GPS satellites. Location information and data received from location sensor 160 can be utilized to identify when an electronic device is at a store or merchant location where an intended purchase will likely occur of an item that is to be shared as a collaborative purchase with other members of a collaborative shopping group. In one embodiment, identifying that the electronic device is at a store or merchant location where the intended purchase of an item can occur is established as one trigger indicative of an intended purchase of a collaborative purchase item.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. Electronic device 100 further includes a housing 170 that contains the components of electronic device 100.

In the description of each of the following figures, reference is also made to specific components illustrated within the preceding figure(s). Similar or same components are presented with the same leading reference number.

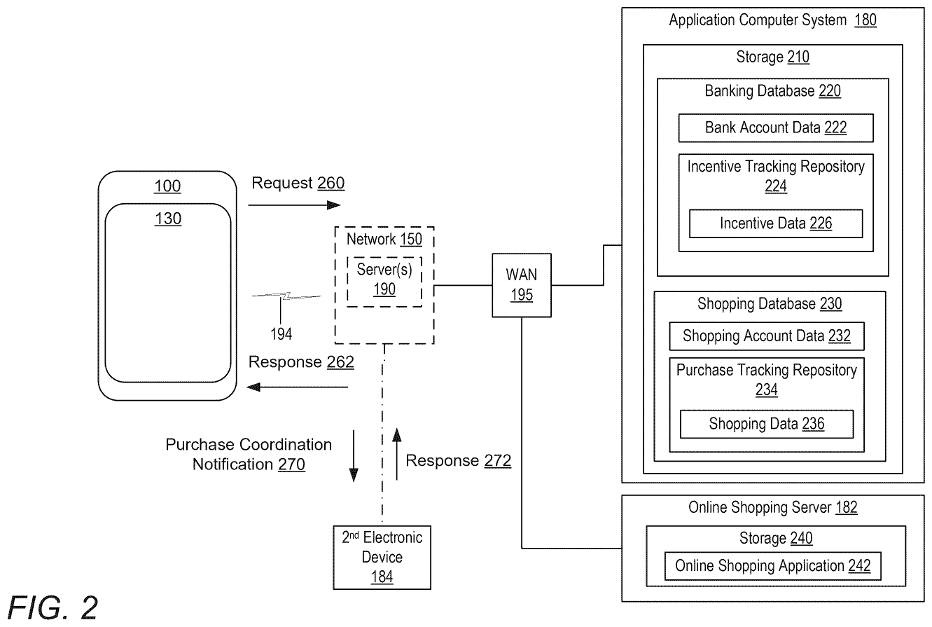

Turning to FIG. 2, with ongoing reference to FIG. 1, electronic device 100 is shown in communication with application computer system 180, online shopping server 182 and second electronic device 184. Electronic device 100 can communicate wirelessly with wireless network 150 via transmission and reception of communication signals 194. Communication network 150 includes communication servers 190 that are communicatively connected to a larger, wide area network (WAN) 195, such as the Internet. Electronic device 100 can also establish connection and communicate with wireless network 150 and with WAN 195 via WiFi router 196 and short-range communication device(s) 164 (FIG. 1).

Application computer system 180 and online shopping server 182 are communicatively coupled to a wide area network (WAN) 195, such as the Internet, to which server 190 of wireless network 150 is also communicatively coupled. Second electronic device 184 is communicatively coupled to wireless network 150 and to server 190. In an embodiment, servers 190 of wireless network 150 support wireless exchange of e-mail, text, data, and other communication between electronic device 100 and application computer system 180, online shopping server 182, and second electronic device 184.

Application computer system 180 can host one or more applications that provide various functions. In an example embodiment, application computer system 180 can host banking applications, shopping applications, content applications, and web browser applications. Application computer system 180 includes storage 210, such as one or more hard drives or solid state drives. Storage 210 can store banking database 220 and shopping database 230. Storage 210 can be or can include an external storage repository (not shown). Banking database 220 and shopping database 230 can support one or more applications 126 of electronic device 100.

Banking database 220 includes bank account data 222 and incentive tracking repository 224. Incentive tracking repository 224 includes incentive data 226, which stores financial or monetary incentives that are offered by banks or other financial entities to persuade a user to purchase various items. Bank account data 222 can include user account data, payment and deposit history, current balances, and payments due. Incentive data 226 can include information about at least one possible financial incentive that is offered in association with the purchase of one or more items. Incentive data 226 can include a threshold minimum purchase amount in order for the incentive to be available or valid and a time period that the incentive is valid for along with an expiration time/date for the incentive.

Shopping database 230 includes shopping account data 232 and purchase tracking repository 234. Purchase tracking repository 234 includes shopping data 236, which stores information related to purchase transactions. Shopping account data 232 can include user account data, merchant information, preferred payment methods, and preferred shipping/delivery methods. Shopping data 236 can include information about items previously purchased or items that are in the process of being purchased by at least one purchaser. In one embodiment, shopping data 236 can be updated with purchase notifications or purchase intentions from various sources, including information about the actual item purchased, the cost of the item purchased the merchandise category associated with the item, and the date/time of the purchase.

According to one aspect of the disclosure, electronic device 100 can transmit a request 260 to application computer system 180 for incentive data 226 with at least one financial incentive that is being offered. In one or more embodiments, a purchase transaction can be completed via online shopping server 182 that is communicatively connected to WAN 195. In yet another embodiment, an intended purchase transaction can be determined when an item is placed in a shopping cart of the online shopping server 182. The purchase transaction and/or intended purchase transaction triggers the electronic device 100 to transmit request 260. Other triggers are possible, including detection of entry by electronic device 100 into a location of a shopping establishment or device/user log on to a shopping website/portal, such as provided by online shopping server 182. Electronic device 100 can receive, in response to the request 260, a first response 262 that contains the incentive data 226 with at least one incentive. In one embodiment, presentation of the incentive is not a response to a request, but is instead provided as a published notification on the shopping website. Electronic device 100 and application computer system 180 can perform a validation and authentication routine prior to the exchange of data and information to provide account verification and security for access by electronic device to incentive data 226.

Online shopping server 182 can host one or more third party online shopping applications that provide access to goods and services. Online shopping server 182 includes storage 240, such as one or more hard drives or solid state drives. Storage 240 can store online shopping application 242.

According to another aspect of the disclosure, electronic device 100 can transmit a purchase coordination notification 270 to second electronic device 184. The purchase coordination notification 270 can inform at least one potential second purchaser or user that is associated with second electronic device 184 that an incentive is potentially available with the collaborative purchase of at least one additional second item. Electronic device 100 can receive, in response to the purchase coordination notification 270, a second response 272 that contains a request to purchase the at least one additional second item by the user of electronic device 100. The second response 272 can include an identification of the additional second item to be purchased and optionally include a second item purchase amount or cost. The second item purchase amount can be determined by the online shopping server 182 and presented on addition of an identifier of the second item to the open purchasing window or shopping cart.

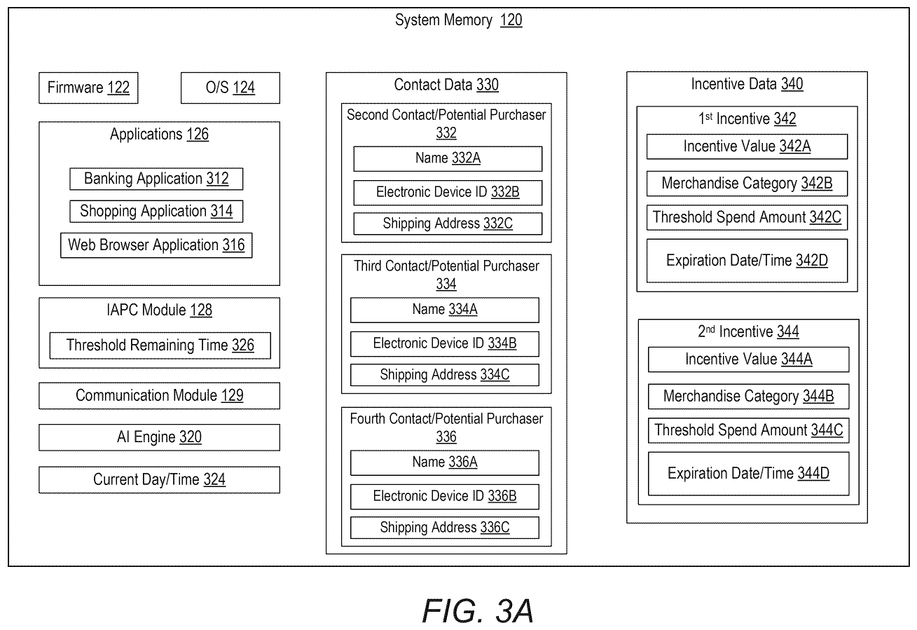

Referring to FIG. 3A, there is shown one embodiment of example contents of system memory 120 of electronic device 100 configured to complete the various processes described herein. System memory 120 includes data, software, and/or firmware modules, including firmware 122, an operating system (O/S) 124, applications 126, incentive alert and purchase coordination (IAPC) module 128, and communication module 129.

Applications 126 include banking application 312, shopping application 314, and web browser application 316. Banking application 312 includes program code that is executed by processor 102 to configure electronic device 100 to access banking services provided by a bank or other financial institution, such as a credit card company, online payment service, etc. Shopping application 314 includes program code that is executed by processor 102 to configure electronic device 100 to access websites to browse and buy products or services from a retailer or service provider. Web browser application 316 includes program code that is executed by processor 102 to configure electronic device 100 to access various websites of the Internet. While applications 126 are shown including three applications, applications 126 can include more or fewer than three applications.

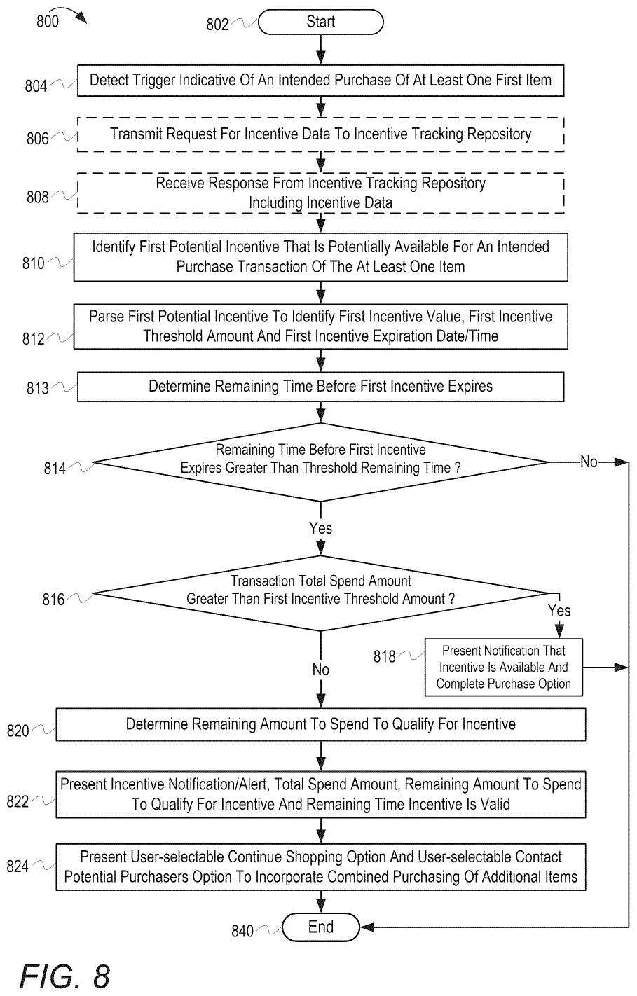

Incentive alert and purchase coordination module 128 includes program code that is executed by processor 102 to configure electronic device 100 to perform the various features of the present disclosure. In one or more embodiments, incentive alert and purchase coordination module 128 configures electronic device 100 to present incentive alerts for an intended purchase of at least one first item and to coordinate purchases of additional items with other users. Incentive alert and purchase coordination module 128 includes threshold remaining time 326. Threshold remaining time 326 is a pre-determined remaining time that an incentive is valid before expiration of the incentive. In one or more embodiments, execution of incentive alert and purchase coordination module 128 by processor 102 configures electronic device 100 to perform the processes presented in the flowcharts of FIGS. 8-10, as will be described below. Communication module 129 configures electronic device 100 to communicate and exchange data with other devices via wireless network 150 and/or WiFi router 196.

System memory 120 includes artificial intelligence (AI) engine 320, and current day/time 324. AI engine 320 accelerates artificial intelligence, natural language processing (NLP), context evaluation (CE), and machine learning applications. Current day/time 324 includes the current day/month/year and the current time of the day.

System memory 120 includes contact data 330. Contact data 330 is a directory or list of known family members, friends, and co-workers including e-mail addresses, messaging addresses and electronic device identifiers (i.e., phone numbers) and physical or shipping addresses where a purchased item can be shipped. In one embodiment, members of contact data 330 can also be potential purchasers that a user of electronic device 100 may want to collaboratively purchase items with in order to obtain a financial offer or incentive.

Contact data 330 includes second contact/potential purchaser 332, third potential purchaser 334, and fourth potential purchaser 336. A user of electronic device 100 can be referred to as the first contact/potential purchaser. While contact data 330 is shown including three contacts/potential purchasers, contact data 330 can include more or fewer than three contacts/potential purchasers. The disclosure assumes that contact data 330 includes at least one contact/potential purchaser.

Each contact/potential purchaser includes an electronic device identifier (ID) that associates the potential purchaser with an electronic device. Second contact/potential purchaser 332 includes a name 332A, an electronic device ID 332B, and a shipping address 332C where items purchased for the second contact/potential user can be shipped. Third contact/potential purchaser 334 includes a name 334A, an electronic device ID 334B, and a shipping address 334C where items purchased for the third contact/potential user can be shipped. Fourth contact/potential purchaser 336 includes a name 336A, an electronic device ID 336B, and a shipping address 336C where items purchased for the fourth contact/potential user can be shipped.

System memory 120 includes incentive data 340. Electronic device 100 can receive incentive data 340 from application computer system 180. Incentive data 340 contains data and information about financial or monetary incentives that are offered by banks or other financial entities to persuade a user to purchase various items. Incentive data 340 includes a first incentive 342 and a second incentive 344.

First incentive 342 includes an incentive value 342A, a merchandise category 342B, an incentive threshold spend amount 342C, and an expiration date/time 342D. Incentive value 342A can be a monetary amount of an offer that can be applied toward a purchase of one or more items. In an example embodiment, a bank credit card may offer a 10 percent incentive (discount) on the amount of a purchase, if the bank credit card is used for the purchase of the items. In one or more embodiments, incentive value 342A can be a non-monetary offer, such as shopping or airline reward points or tickets to an event. Merchandise category 342B is the type of merchandise that the incentive can be used for. In one example embodiment, an incentive may be valid for purchases of products, but not services. Incentive threshold spend amount 342C is a minimum total amount that is to be spent on purchases in order to obtain or qualify for the incentive. For example, in one embodiment, incentive threshold spend amount 342C can be US $100 dollars. Expiration date/time 342D is the expiration date and time, after which the incentive is no longer valid.

Second incentive 344 similarly includes an incentive value 344A, a merchandise category 344B, a threshold spend amount 344C, and expiration date/time 344D.

Turning to FIG. 3B, there is shown additional details of example contents of system memory 120 of electronic device 100 configured to complete the various processes described herein. System memory 120 includes coordinated shopping data 360. Coordinated shopping data 360 contains data and information about purchases and intended purchases that can be used to coordinate purchases with other users or potential purchases in order to qualify for a financial incentive.

Coordinated shopping data 360 includes first intended purchase item 362, second intended purchase item 366, and third intended purchase item 370. While three intended purchase items are shown in coordinated shopping data 360, coordinated shopping data 360 can have more or less than three items.

First intended purchase item 362 includes first item name or identifier 364A, first item merchandise category 364B, first item quantity 364C, first item cost amount 364D, and first item purchaser 364E. First intended purchase item 362 is an item that corresponds to a pending transaction. In one embodiment, first intended purchase item 362 can be an item that has been added to a shopping cart of an online shopping application. First intended purchase item 362 includes a first item name or identifier 364A of the first intended purchase item and a merchandise category and type 364B that identifies the product or merchandise category and type associated with the first intended purchase item 362. First intended purchase item 362 further includes a first intended purchase item quantity 364C that corresponds to the number of items that have been selected for purchase or added to a shopping cart. First intended purchase item 362 further includes a first intended purchase item cost amount 364D that is the cost of purchasing the first intended purchase item. First intended purchase item 362 further includes the first item purchaser 364E. In one embodiment, the first item purchaser 364E is the user of electronic device 100.

Second intended purchase item 366 includes second item name or identifier 368A, second item merchandise category 368B, second item quantity 368C, second item cost amount 368D, and second item purchaser 368E. Third intended purchase item 370 includes third item name or identifier 372A, third item merchandise category 372B, third item quantity 372C, third item cost amount 372D, and third item purchaser 372E. In one embodiment, first item purchaser 364E, second item purchaser 368E and third item purchaser 372E are members of the set of contact data 330.

System memory 120 includes transaction total spend amount 380, remaining amount to qualify for incentive 382, and remaining time incentive is valid 384. Transaction total spend amount 380 is the sum of all the item cost amounts in coordinated shopping data 360 (i.e., the sum of first item cost amount 364D, second item cost amount 368D, and third item cost amount 372D). Remaining amount to qualify for incentive 382 is the difference between the incentive threshold spend amount (e.g., first incentive threshold spend amount 342C) and the transaction total spend amount 380. The remaining amount to qualify for incentive 382 can be presented or outputted on display 130 along with an incentive notification of a potential incentive to alert a user of electronic device 100 of an additional spend amount required to obtain the incentive. Remaining time incentive is valid 384 is the time difference between the current day/time 324 and the expiration date/time of the potential incentive (e.g., first potential incentive expiration date/time 342D). The remaining time incentive is valid 384 can be also presented or output on display 130 to alert a user of electronic device 100 of the remaining time that the potential incentive is valid.

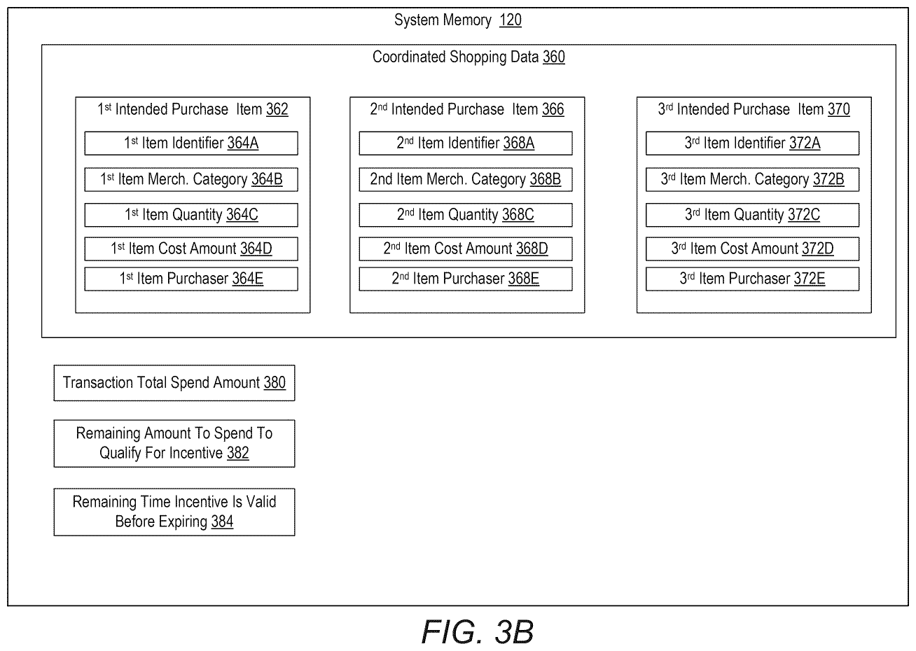

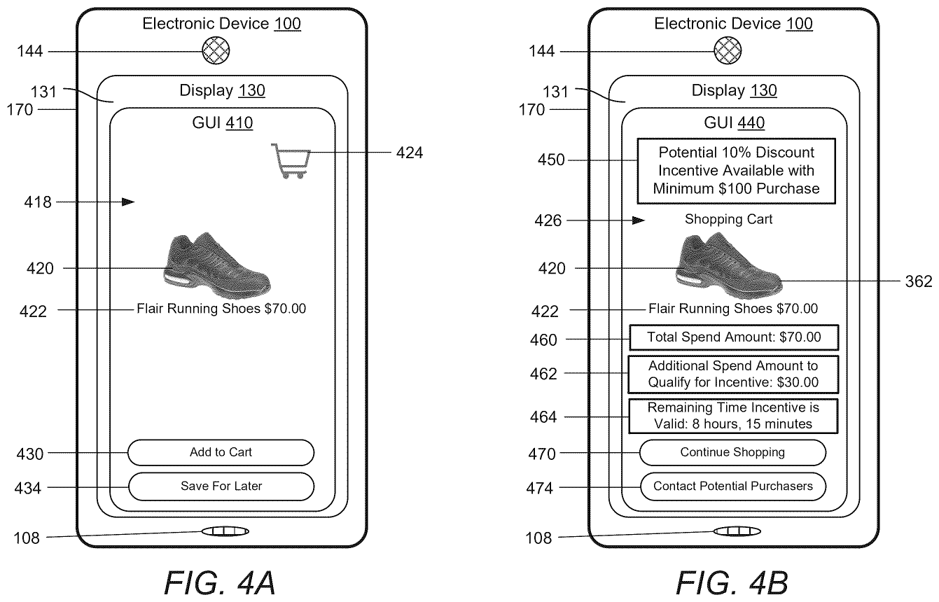

With reference to FIG. 4A, electronic device 100 is shown with an example shopping graphical user interface (GUI) 410 presented on display 130. Shopping GUI 410 allows a user of electronic device 100 to purchase goods and services from a merchant via an online transaction. In one embodiment, electronic device 100 can access a shopping website using shopping application 314 executing on processor 102. Shopping GUI 410 includes a shopping page 418 with one or more items or products that may have been searched for by a user or simply presented on opening of the shopping page 418. In an example embodiment, GUI 410 includes shoes 420 and a product description and cost or price 422. Shopping website GUI 410 further includes a user-selectable option 430 to add shoes 420 to shopping cart 424 and a user-selectable option 434 to save the selected item to be purchased at a later time.

With reference to FIG. 4B, electronic device 100 is shown with an example incentive notification graphical user interface (GUI) 440 presented on display 130. Incentive notification GUI 440 is shown after a user has selected at least one product for purchase. Incentive notification GUI 440 includes a shopping cart summary 426 that includes a total cost of the item(s) or product(s) (e.g., shoes 420) that have been selected by a user of electronic device 100 for an intended purchase or intended purchase transaction. An item is referred to herein as an intended purchase item after an item has been added to shopping cart 424, or otherwise selected for purchase. Referring to FIG. 3B, shoes 420 can be identified as first intended purchase item 362 having been selected by the local device user. Returning to FIG. 4B, incentive notification GUI 440 includes an incentive notification alert 450 (i.e., a message or notification) that a financial (or other) incentive (e.g., first incentive 342) is potentially available to reduce the cost of items purchased. Incentive notification alert 450 can include the incentive value (e.g., first incentive value 342A) and the threshold spend amount (e.g., first incentive threshold spend amount 342C) that is required for the incentive to be available or to be applied.

Incentive notification GUI 440 includes a current total spend amount 460 for the total cost of items that have been selected for purchase (i.e., total cost of items in shopping cart), an additional spend amount 462 required to qualify for or obtain the potential incentive, and a remaining time 464 that the potential incentive is available or valid.

In the example of FIG. 4B, the incentive notification alert 450 includes an incentive value of a 10 percent discount off of the total spend amount, and a minimum threshold spend amount of $100. The current total spend amount 460 is shown as $70.00, the additional spend amount 462 required to qualify for or obtain the potential incentive is shown as $30.00, and the remaining time 464 that the potential incentive is available or valid is shown as 8 hours and 15 minutes.

Incentive notification GUI 440 further includes continue shopping option 470 and contact potential purchasers option 474. When selected, continue shopping option 470, enables electronic device 100 to continue an online shopping interface (i.e., shopping GUI 410) such that a user can add at least one additional second item to shopping cart 424 in order to obtain or qualify for the potential financial incentive. When selected, contact potential purchasers option 474 enables electronic device 100 to select at least one potential second purchaser from a set of potential second purchasers to receive purchase coordination notification 270 (FIG. 2) that facilitates electronic notification of and coordination with the at least one potential second purchaser associated with a communicatively connected second electronic device (e.g., second electronic device 184, FIGS. 1 and 2) to incorporate combined purchasing of additional items by the at least one potential second purchaser within the intended purchase transaction.

According to one aspect of the disclosure, electronic device 100 can detect a trigger indicative of an intended purchase transaction having a transaction total spend amount 380. In one embodiment, the trigger can be the addition of at least one intended purchase item to shopping cart 424. Electronic device 100 identifies a first potential incentive (e.g., first incentive 342) applicable to the intended purchase transaction and having a first incentive threshold spend amount 342C to trigger receipt of a corresponding incentive. In response to identifying the first potential incentive, electronic device 100 presents a first incentive notification 450 on display 130. The first incentive notification indicates that the first incentive 342 is potentially available if the transaction total spend amount of the intended purchase transaction meets or exceeds the first incentive threshold spend amount 342C. Electronic device 100 activates and presents at least one first user-selectable option (e.g., contact potential purchasers option 474) on the display that facilitates electronic notification of and coordination with at least one potential second purchaser 332 associated with a communicatively connected second electronic device 184 to incorporate combined purchasing of additional items by the at least one potential second purchaser within the intended purchase transaction.

According to another aspect of the disclosure, electronic device 100 can present incentive notification GUI 440 including incentive notification alert 450 and continue shopping option 470 on display 130. In response to detecting selection of continue shopping option 470, electronic device 100 enables continuation of the intended purchase transaction to include addition of at least one additional second item (e.g., second intended purchase item 366). Electronic device 100 updates the transaction total spend amount 380 to include a cost (e.g., second item cost amount 368D) of the at least one additional second item and generates a notification/alert identifying when the updated transaction total spend amount reaches the first incentive threshold spend amount 342C.

According to an additional aspect of the disclosure, electronic device 100 can detect addition of at least one first item 362 to an online shopping cart 424. In response to detecting an addition of each subsequent item to the online shopping cart 424, electronic device 100 updates both the transaction total spend amount 380 and a difference (i.e., remaining spend amount to spend to qualify for incentive 382) between the first incentive threshold spend amount 342C and the transaction total spend amount 380. Electronic device 100 presents an updated difference (e.g. additional amount to spend to qualify for incentive 462) on display 130 of the electronic device along with a remaining time 464 to receive the first potential incentive 342.

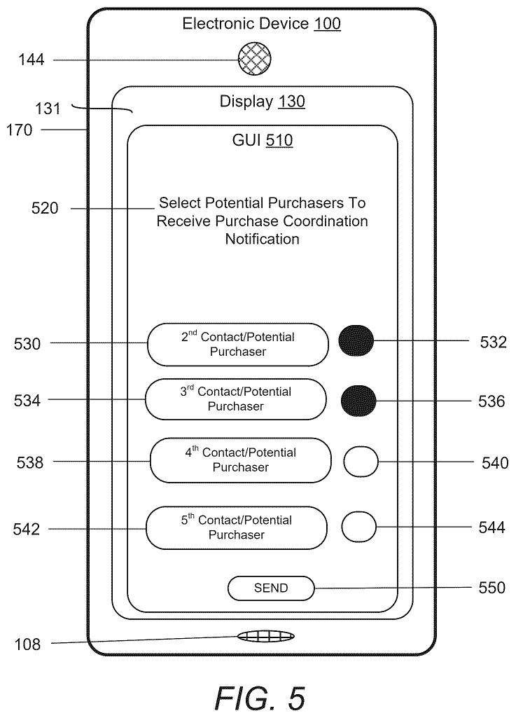

Referring to FIG. 5, electronic device 100 is shown with example select potential purchasers (SPP) graphical user interface GUI 510 presented on display 130. SPP GUI 510 is presented after a user has selected contact potential purchasers option 474 of FIG. 4A. SPP GUI 510 includes a description 520 of the purpose of SPP GUI 510 and a listing of several potential purchasers for a user of electronic device 100 to select one or more potential purchasers to receive purchase coordination notification 270.

Specifically, SPP GUI 510 includes several specific potential purchasers identified by names and/or other unique identifier with associated on/off indicators that indicate when/whether a specific potential purchaser has been selected to receive purchase coordination notification 270. SPP GUI 510 includes second contact/potential purchaser 530, with option on/off indication 532, third contact/potential purchaser 534, with option on/off indication 536, fourth contact/potential purchaser 538, with option on/off indication 540, and fifth contact/potential purchaser 542, with option on/off indication 544. It is appreciated that the labels for each of the selectable contacts/potential purchasers can be the actual names of the individuals as taken from the stored contact data 330 or inputted locally by the user within SPP GUI 510.

SPP GUI 510 further includes SEND selector button 550 that triggers the transmission of the requests for purchase coordination to the selected ones (e.g., 530 and 534) of the listed potential purchasers. In FIG. 5, second contact/potential purchaser option 530 and third contact/potential purchaser option 534 have been selected to receive a purchase coordination notification 270 with respective option on/off indications 532 and 536 filled in or checked.

According to one aspect of the disclosure, electronic device 100 can detect selection of contact potential purchasers option 474 (FIG. 4B). In response to detecting selection of contact potential purchasers option 474, electronic device 100 presents SPP GUI 510 on display 130. SPP GUI 510 includes user-selectable options (i.e., second contact/potential purchaser 530, third contact/potential purchaser 534, fourth contact/potential purchaser 538, and fifth contact/potential purchaser 542) to select at least one potential second purchaser from the set of potential second purchasers (e.g., potential purchasers 332, 334 and 336) to receive purchase coordination notification 270. In response to detecting selection of at least one potential purchaser (e.g., second contact/potential purchaser 332), electronic device 100 transmits the purchase coordination notification 270 to the second electronic device 184 associated with the at least one potential contact/second potential purchaser 332. The purchase coordination notification 270 informs the at least one potential second contact/potential purchaser that an incentive (e.g., first incentive 342) is potentially available with the collaborative purchase of at least one additional second item (e.g., second intended purchase item 366).

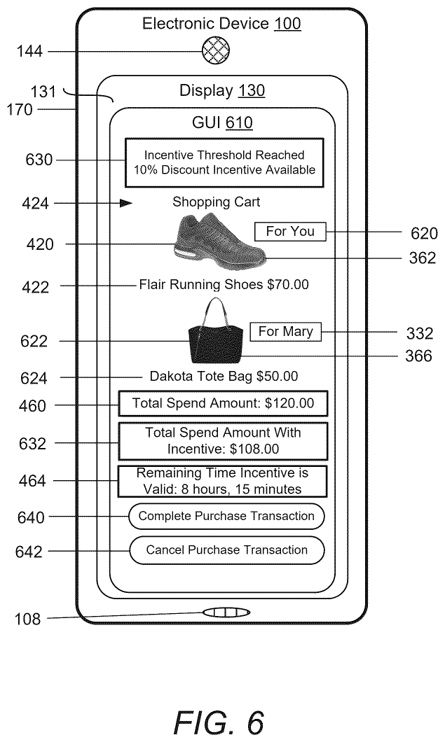

Turning to FIG. 6, electronic device 100 is shown with an example coordinated purchaser shopping (CPS) graphical user interface GUI 610 presented on display 130. CPS GUI 610 is presented after a response 272 has been received from second electronic device 184 to the purchase coordination notification 270 to purchase at least one additional second item. The response 272 includes a request to purchase at least one additional second item (e.g., second intended purchase item 366) via a coordinated purchase.

CPS GUI 610 includes shopping cart 424 that includes an item or product (e.g., shoes 420 corresponding to first intended purchase item 362) that has been selected by a user of electronic device 100 for an intended purchase transaction. CPS GUI 610 includes a product description and cost or price 422 and the purchaser 620 of the first intended purchase item 362. In one embodiment, the purchaser 620 of the first intended purchase item 362 can be the user of electronic device 100.

CPS GUI 610 further includes shopping cart 424 that includes another item or product (e.g., tote bag 622 corresponding to second intended purchase item 366) that was selected for purchase by a potential purchaser (e.g., second potential purchaser 332) and received from second electronic device 184 as part of second response 272. CPS GUI 610 includes a product description and cost or price 624, and an identifier/indication of the second potential purchaser 332 of the second intended purchase item 366.

CPS GUI 610 includes a notification 630 (i.e., a message or notification) that the first incentive threshold spend amount 342C has been reached and that the first incentive 342 is now available to be used towards the purchase of items in shopping cart 424. CPS GUI 610 includes an updated current total spend amount 460 for the total cost of items in shopping cart 424. The updated current total spend amount 460 is calculated by summing the first intended purchase item cost amount 364D and the second intended purchase item cost amount 368D. CPS GUI 610 includes a total spend amount with incentive 632 and the remaining time 464 that the potential incentive is available or valid. Total spend amount with incentive 632 is the total cost of items purchased with the incentive applied to reduce the overall total cost. In one embodiment, the total spend amount with incentive 632 may be displayed after the incentive threshold spend amount has been met or exceeded.

CPS GUI 610 further includes complete purchase transaction option 640 and cancel purchase transaction option 642. When selected, complete purchase transaction option 640, enables electronic device 100 to complete the purchase transaction using the first incentive 342 to purchase the first intended purchase item 362 and the second intended purchase item 366. In the example embodiment, of FIG. 6, if the value of the first incentive 342 is a 10 percent discount on the total spend amount and the total spend amount 460 is $120.00, the total spend amount would be reduced by $12.00 and the total spend amount with incentive 632 to complete the purchase transaction would be $108.00. When selected, cancel purchase transaction option 642, enables electronic device 100 to cancel the pending purchase transaction.

According to one aspect of the disclosure, electronic device 100 receives, from second electronic device 184, a response 272 to the purchase coordination notification 270. The response 272 includes a request to purchase at least one additional second item (e.g., second intended purchase item 366) having a second item purchase cost amount 368D. Electronic device 100 adds the at least one second item to the purchase transaction and updates the transaction total spend amount 380 by summing the first item purchase cost amount 364D and the second item purchase cost amount 368D. Electronic device 100 determines if the transaction total spend amount 380 is greater than the first incentive threshold spend amount 342C. In response to determining that the transaction total spend amount 380 is greater than the first incentive threshold spend amount 342C, electronic device 100 presents a message 630 indicating that the first incentive threshold spend amount has been reached and that the first incentive 342 is now available. Electronic device 100 enables completion of the purchase transaction using the first incentive 342 to purchase the at least one first item 362 and the at least one additional second item 366.

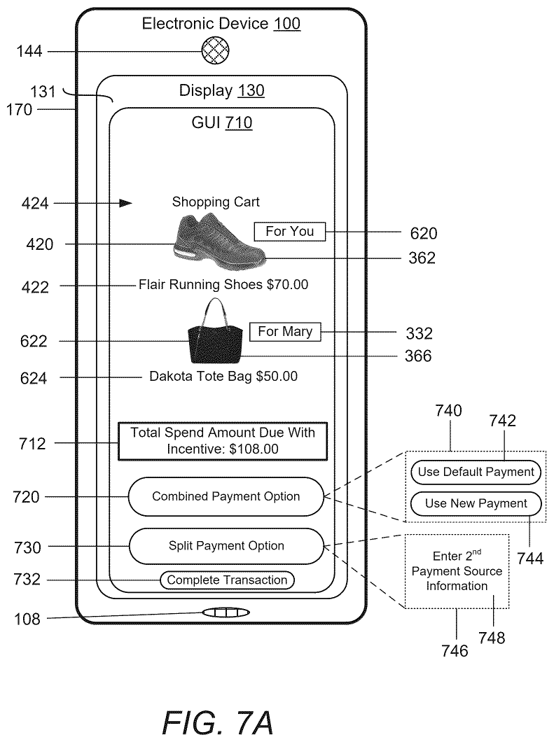

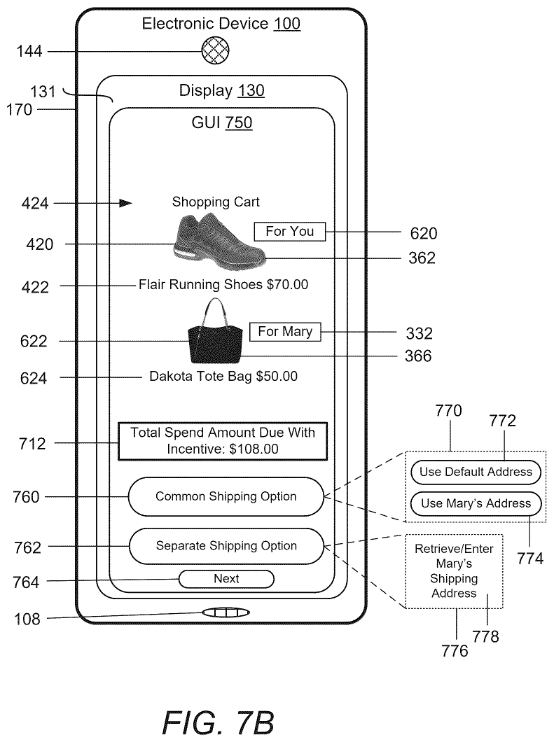

With reference to FIG. 7A, electronic device 100 is shown with an example payment graphical user interface (GUI) 710 presented on display 130. Payment GUI 710 is presented after complete purchase transaction option 640 (FIG. 6) has been selected by a user. Payment GUI 710 includes the total spend amount due with the incentive 712. Payment GUI 710 includes a user-selectable combined payment option 720 to initiate processing to complete payment for the combined purchase transaction by the user of electronic device 100. The combined purchase transaction includes the combined purchase of first intended purchase item 362 and second intended purchase item 366 using a single payment source. After combined payment option 720 has been selected, option window 740 is presented on display 130. Option window 740 includes a use default payment option 742 and use new payment option 744. Use default payment option 742 enables a stored default payment method to be used for the payment of the combined purchase transaction. Use new payment option 744 enables a new payment method to be applied for the payment of the combined purchase transaction. In one embodiment, the new payment method can be payment from a second potential purchaser.

Payment GUI 710 further includes a user-selectable split payment option 730 to initiate processing to complete payment for the purchase transaction by each respective purchaser of the combined purchase transaction. The combined purchase transaction includes the combined purchase of first intended purchase item 362 and second intended purchase item 366. When selected, split payment option 730 enables electronic device 100 to initiate split payment processing to enable payment for the first intended purchase item 362 by the user of electronic device 100 and a separate payment for the at least one additional second intended purchase item 366 by the second potential purchaser 332 associated with second electronic device 184. After split payment option 730 has been selected, option window 746 is presented on display 130. Option window 746 includes enter second payment source information option 748. Enter second payment source information option 748 enables a second payment method to be applied toward the payment of the combined purchase transaction. In one embodiment, second electronic device 184 can automatically transmit payment details in a secure manner to be applied to the combined payment for the at least one additional second purchase item. Payment GUI 710 further includes a user-selectable complete transaction option 732 to initiate processing to complete the purchase transaction.

According to an additional aspect of the disclosure, electronic device 100 presents at least one payment option from among a first user-selectable combined payment option 720 to initiate processing to complete payment for the combined purchase transaction by a first user of electronic device 100 and a second user-selectable split payment option 730 to initiate a split payment processing to enable payment for the at least one first item by the first user of electronic device 100 and a separate payment for the at least one additional second item by a second purchaser 332 of second electronic device 184.

With reference to FIG. 7B, electronic device 100 is shown with an example shipping graphical user interface (GUI) 750 presented on display 130. Shipping GUI 750 is presented after complete purchase transaction option 640 (FIG. 6) has been selected by a user. Shipping GUI 750 includes the total spend amount due with the incentive 712. Shipping GUI 750 includes the first intended purchase item 362 and the second intended purchase item 366 to be shipped.

Shipping GUI 750 further includes a user-selectable common shipping option 760 to initiate processing to provide one address as a common shipping destination for the combined purchase transaction and a user-selectable separate shipping option 762 to initiate processing to provide separate address for each respective intended purchase item. Shipping GUI 750 provides a second user-selectable shipping option that provides a first address as a first shipping destination for the at least one first item and at least one second address as a second shipping destination for the at least one additional second item.

When selected, common shipping option 760 enables a common first address (i.e., the address of the user of electronic device 100) as the shipping destination for both the first intended purchase item 362 and the at least one additional second intended purchase item 366. After common shipping option 760 has been selected, option window 770 is presented on display 130. Option window 770 includes a use default shipping address 772 and use second potential purchaser shipping address option 774. Use default shipping address 772 enables a stored default shipping address to be used as the shipping destination for the combined purchase transaction. Use second potential purchaser shipping address option 774 enables the address of the second potential purchaser (i.e., Mary) to be used as the shipping destination for the combined purchase transaction.

When selected, separate shipping option 762 enables a first address (i.e., the address of the user of electronic device 100) as the shipping destination for the first intended purchase item 362 and at least one second address 332C as the shipping destination for the at least one additional second intended purchase item 366. After separate shipping option 762 has been selected, option window 776 is presented on display 130. Option window 776 includes a retrieve/enter second potential purchaser shipping address option 778. Retrieve/enter second potential purchaser shipping address option 778 enables the shipping address of the second potential purchaser (i.e., Mary) to be retrieved/entered. Shipping GUI 750 further includes a user-selectable next option 764 to transition to payment GUI 710 to complete payment.

According to further aspect of the disclosure, electronic device 100 presents at least one shipping option from among a first user-selectable common shipping option 760 that provides a first address as a common shipping destination for the combined purchase transaction and a second user-selectable separate shipping option 762 that provides a first address as a first shipping destination for the at least one first item 362 and at least one second address as a second shipping destination for the at least one additional second item 366.

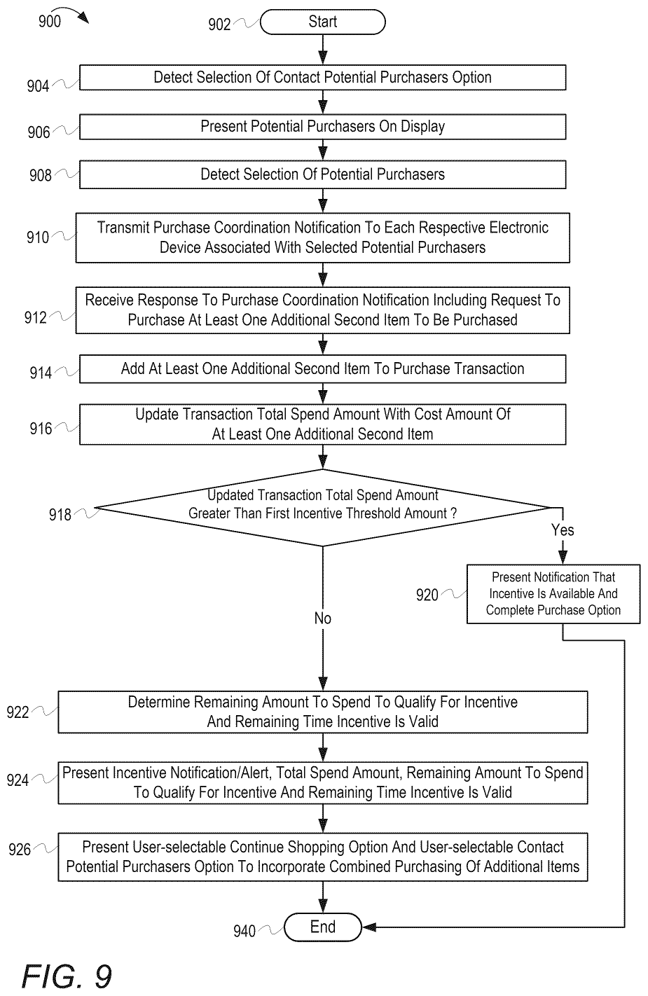

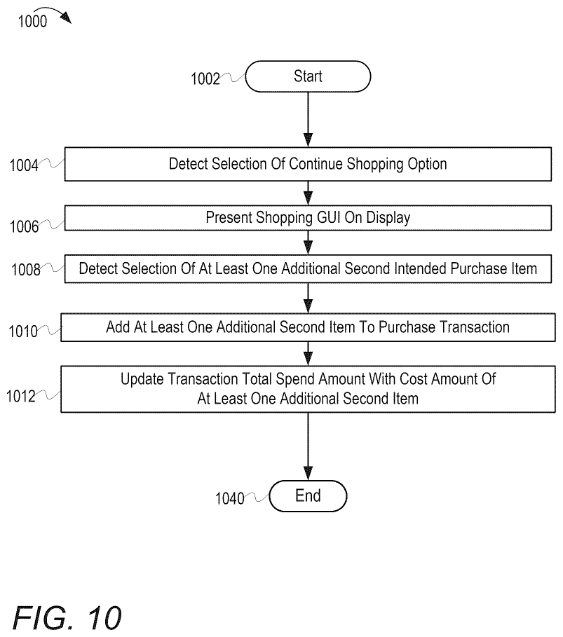

FIG. 8 depicts method 800 by which electronic device 100 activates and presents an incentive notification/alert that at least one incentive is potentially available for an intended purchase and a contact potential purchasers option to coordinate purchases with other users in order to obtain the incentive. FIG. 9 depicts method 900 by which electronic device 100 enables the selection of potential second purchasers and coordinates purchases with other users. FIG. 10 depicts method 1000 by which electronic device 100 enables continued shopping for at least one additional second item.

The description of methods 800, 900 and 1000 will be described with reference to the components and examples of FIGS. 1-7B. The operations depicted in FIGS. 8-10 can be performed by electronic device 100 or any suitable electronic device that includes the one or more functional components of electronic device 100 that provide/enable the described features. One or more of the processes of the methods described in FIGS. 8-10 may be performed by processor 102 executing program code associated with incentive alert and purchase coordination module 128 and configuring the electronic device to perform the various processes.

With specific reference to FIG. 8 method 800 begins at the start block 802. At block 804, method 800 includes detecting a trigger that is indicative of the intended purchase of at least one first item (e.g., first intended purchase item 362). In one embodiment, the trigger can be the initiation of at least one shopping application 314 or the addition of at least one item to a shopping cart 424. Method 800 optionally includes transmitting a request 260 for incentive data 226 to incentive tracking repository 224 (block 806) and receiving a response 262 from incentive tracking repository 224 including the incentive data 226 (block 808). The received incentive data 226 is stored as incentive data 340 to system memory 120. In one alternate embodiment, the incentive data 340 is automatically presented to the user once the device registers or connects to the merchant website via the online shopping application 314.

Method 800 includes identifying (from incentive data 340) a first potential incentive (e.g., first incentive 342) that is potentially available for an intended purchase transaction of at least one item (block 810). Method 800 includes parsing the first potential incentive (e.g., first incentive 342) to identify the incentive value 342A, the threshold spend amount 342C, and the expiration date/time 342D of the first incentive 342 (block 812). Method 800 includes determining the remaining time that the first incentive is valid before expiring 384 (block 813). The remaining time that the first incentive is valid before expiring 384 is calculated by determining the difference between the current day/time 324 and first incentive expiration date/time 342D.

Method 800 includes determining if the remaining time that the first incentive is valid before expiring 384 is greater than the threshold remaining time 326 (decision block 814). The threshold remaining time 326 is a minimum time value that is required to contact potential second purchasers and get at least one of the potential second purchasers to respond with a selection of a purchase item in order to complete the shopping transaction. The threshold remaining time 326 can be preset (e.g., 1 hour) and may be dynamically adjustable by AI engine 320 or processor 102 based on studying historical response times for the second purchasers to respond to a request for collaborative purchasing. In response to determining that the remaining time that the first incentive is valid before expiring 384 is not greater than the threshold remaining time 326, method 800 ends at end block 840. In response to determining that the remaining time that the first incentive is valid before expiring 384 is greater than the threshold remaining time 326, method 800 includes determining if the transaction total spend amount 380 is greater than the threshold spend amount 342C of the first incentive 342 (decision block 816). In one embodiment, the transaction total spend amount 380 can be the sum of the cost of items in shopping cart 424. For example, if the first intended purchase item 362 is the only item in shopping cart 424, the transaction total spend amount 380 is equal to the first item cost amount 364D.

In response to determining that the transaction total spend amount 380 is greater than the threshold spend amount 342C, method 800 includes presenting a notification/alert 630 and complete purchase transaction option 640 on display 130 (block 818). Notification/alert 630 indicates that the transaction total spend amount has met or exceeded the first incentive threshold spend amount 342C and the first incentive is available to be used towards the intended purchase transaction. Method 800 then terminates at end block 840.

In response to determining that the transaction total spend amount 380 is not greater than the threshold spend amount 342C, method 800 includes determining the remaining amount to spend to qualify for the incentive 382 (block 820). The remaining amount to qualify for the incentive 382 is calculated by determining the difference between the first incentive threshold spend amount 342C and the transaction total spend amount 380.

Method 800 includes presenting, on display 130, the first incentive notification/alert 450, the intended purchase transaction total spend amount 380, the remaining amount to spend to qualify for the incentive 382, and the remaining time that the first potential incentive is valid 384 (block 822). The first incentive notification/alert 450 indicates that the first potential incentive is potentially available if the transaction total spend amount 380 of the intended purchase transaction meets or exceeds the first incentive threshold spend amount 342C. Method 800 includes presenting user-selectable continue shopping option 470 and user-selectable contact potential purchasers option 474 on display 130 (block 824). Method 800 ends at end block 840.

FIG. 9 depicts method 900 by which electronic device 100 enables the selection of potential second purchasers and coordinates purchases with other users. With reference to FIG. 9 method 900 begins at the start block 902. At block 904, method 900 includes detecting selection of contact potential purchasers option 474 by a user of electronic device 100. Method 900 includes presenting a set of potential purchasers (e.g. potential purchasers 332, 334, and 336) on display 130 (block 906) and detecting selection of at least one potential purchaser option (e.g. at least one of potential purchaser options 530, 534, and 538) to receive purchase coordination notification 270 (block 908).

Method 900 includes transmitting the purchase coordination notification 270 to each respective electronic device that is associated with the selected potential purchaser(s) (block 910). In one example embodiment, if the selected potential purchaser is second potential purchaser 332, electronic device 100 transmits the purchase coordination notification 270 to the second electronic device 184 associated with the second potential purchaser 332. The purchase coordination notification 270 informs the at least one potential second potential purchaser that an incentive (e.g., first incentive 342) is potentially available with the collaborative purchase of at least one additional second item (e.g., second intended purchase item 366). The amount remaining to spend in order to meet the incentive threshold spend amount can also be provided to inform the second potential purchaser of the amount needed to be spent.

Method 900 includes receiving, from second electronic device 184, a second response 272 to the purchase coordination notification 270 (block 912). Second response 272 includes a request to purchase the at least one additional second item for the second user (i.e., second potential purchaser 332) of second electronic device 184. The second response 272 can include an identification of the additional second item to be purchased and a second item purchase amount or cost. It is appreciated that the second user would be provided with (or would have) access to the merchant account to identify the available items for purchase that can be added to the transaction. In one embodiment, the merchant details can be shared with the request for collaboration as a link to allow the second purchaser to access the merchant online shopping portal with a link to a collaborative shopping cart of the first user.

Method 900 includes adding the at least one additional second item (e.g., second intended purchase item 366) to the intended purchase transaction (block 914) and updating the transaction total spend amount 380 by summing the first intended purchase item cost amount 364D and the cost amount of the intended purchase items in second response 272 (e.g., second intended purchase item cost amount 368D) (block 916).

Method 900 includes determining if the updated transaction total spend amount 380 is greater than the threshold spend amount 342C of the first incentive 342 (decision block 918). In response to determining that the updated transaction total spend amount 380 is greater than the threshold spend amount 342C, method 900 includes presenting a notification/alert 630 and complete purchase transaction option 640 on display 130 (block 920). Notification/alert 630 indicates that the updated transaction total spend amount has met or exceeded the first incentive threshold spend amount 342C and the first incentive is now available to be used towards the intended purchase transaction. Method 900 then terminates at end block 940.

In response to determining that the updated transaction total spend amount 380 is not greater than the threshold spend amount 342C, method 900 includes determining the remaining amount to qualify for the incentive 382 and the remaining time that the first potential incentive is valid 384 (block 922). The remaining amount to qualify for the incentive 382 is calculated by determining the difference between the first incentive threshold spend amount 342C and the updated transaction total spend amount 380. The remaining time that the first potential incentive is valid 384 is calculated by determining the difference between the current day/time 324 and first incentive expiration date/time 342D.

Method 900 includes presenting, on display 130, the first incentive notification/alert 450, the updated intended purchase transaction total spend amount 380, the remaining amount to spend to qualify for the incentive 382, and the remaining time that the first potential incentive is valid 384 (block 924). The first incentive notification/alert 450 indicates that the first potential incentive is potentially available if the transaction total spend amount 380 of the intended purchase transaction meets or exceeds the first incentive threshold spend amount 342C. Method 900 includes presenting user-selectable continue shopping option 470 and user-selectable contact potential purchasers option 474 on display 130 (block 926). Method 900 ends at end block 940.

FIG. 10 depicts method 1000 by which electronic device 100 enables continued shopping for at least one additional second item. With reference to FIG. 10 method 1000 begins at the start block 1002. At block 1004, method 1000 includes detecting selection of continue shopping option 470 by a user of electronic device 100. Method 1000 includes presenting shopping GUI 410 on display 130 (block 1006) to continue the intended purchase transaction to include addition of at least one additional second item.

Method 1000 includes detecting the selection of at least one additional second item to be purchased (e.g., second intended purchase item 366) (block 1008) and adding the at least one additional second item (e.g., second intended purchase item 366) to the intended purchase transaction (block 1010). Method 1000 includes updating the transaction total spend amount 380 by summing the first intended purchase item cost amount 364D and the second intended purchase item cost amount 368D) (block 1012). Method 1000 ends at end block 1040.

In the above-described methods of FIGS. 8-10, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a communication system;
a memory having stored thereon an incentive alert and purchase coordination (IAPC) module for presenting incentive alerts for an intended purchase and coordinating purchases with other users; and
at least one processor communicatively coupled to the display, the communication system, and the memory, the at least one processor executing program code of the IAPC module and configuring the electronic device to:
detect a trigger indicative of an intended purchase transaction having a transaction total spend amount;
identify a first potential incentive applicable to the intended purchase transaction and having a first incentive threshold spend amount to trigger receipt of a corresponding incentive; and
in response to identifying the first potential incentive:
present a first incentive notification on the display, the first incentive notification indicating that the first potential incentive is potentially available if the transaction total spend amount of the intended purchase transaction meets or exceeds the first incentive threshold spend amount; and
activate and present at least one first user-selectable option on the display that facilitates electronic notification of and coordination with at least one potential second purchaser associated with a communicatively connected second electronic device to incorporate combined purchasing of additional items by the at least one potential second purchaser within the intended purchase transaction.

2. The electronic device of claim 1, wherein the at least one processor further configures the electronic device to:
present a first graphical user interface (GUI) on the display, the first GUI including the first incentive notification and a second user-selectable option to continue shopping for at least one additional second item in order to qualify for the first potential incentive; and
in response to detecting selection of the second user-selectable option:
enable continuation of the intended purchase transaction to include addition of the at least one additional second item;
update the transaction total spend amount to include a cost of the at least one additional second item; and
generate an alert identifying when the updated transaction total spend amount reaches the first incentive threshold spend amount.

3. The electronic device of claim 1, wherein the at least one processor further configures the electronic device to:
detect selection of the at least one first user-selectable option;
in response to detecting selection of the at least one first user-selectable option, present a second GUI on the display, the second GUI including a third user-selectable option to select the at least one potential second purchaser from a first set of potential second purchasers to receive a purchase coordination notification; and
in response to detecting selection of the at least one potential second purchaser followed by the third user-selectable option, transmit the purchase coordination notification to the second electronic device associated with the at least one potential second purchaser, the purchase coordination notification informing the at least one potential second purchaser that the first potential incentive is potentially available with collaborative purchase of at least one additional second item.

4. The electronic device of claim 3, wherein the at least one processor further configures the electronic device to:
receive, from the second electronic device, a response to the purchase coordination notification, the response including a request to purchase at least one additional second item having a second item purchase amount;
add the at least one second item to the purchase transaction;
update the transaction total spend amount by summing a first item purchase amount and the second item purchase amount;
determine if the transaction total spend amount is greater than the first incentive threshold spend amount; and
in response to determining that the transaction total spend amount is greater than the first incentive threshold spend amount:
present a message indicating that the first incentive threshold spend amount has been reached and that the first incentive is now available; and
enable completion of the purchase transaction using the first incentive to purchase the at least one first item and the at least one additional second item.

5. The electronic device of claim 4, wherein the at least one processor further configures the electronic device to:
present at least one payment option from among:
a first user-selectable payment option to initiate processing to complete payment for the combined purchase transaction by a first user of the electronic device; and
a second user-selectable payment option to initiate a split payment processing to enable payment for the at least one first item by the first user of the electronic device and a separate payment for the at least one additional second item by a second user of the second electronic device.

6. The electronic device of claim 4, wherein the at least one processor further configures the electronic device to:
present at least one shipping option from among:
a first user-selectable shipping option that provides a first address as a common shipping destination for the combined purchase transaction; and
a second user-selectable shipping option that provides a first address as a first shipping destination for the at least one first item and at least one second address as a second shipping destination for the at least one additional second item.

7. The electronic device of claim 1, wherein the at least one processor further configures the electronic device to:
determine that the transaction total spend amount is less than the first incentive threshold spend amount;
determine a difference between the first incentive threshold spend amount and the transaction total spend amount; and
output the difference along with the first incentive notification of the first potential incentive to alert a user of an additional spend amount required to obtain the first potential incentive.

8. The electronic device of claim 1, wherein the at least one processor further configures the electronic device to:
identify an expiration time of the first potential incentive;
determine a remaining time that the first potential incentive is valid; and
present the remaining time that the first potential incentive is valid on the display.

9. The electronic device of claim 1, wherein the at least one processor further configures the electronic device to:
detect addition of at least one first item to an online shopping cart; and
in response to detecting an addition of each subsequent item to the online shopping cart:
update both the transaction total spend amount and a difference between the first incentive threshold spend amount and the transaction total spend amount; and
present an updated difference on the display of the electronic device along with a remaining time to receive the first potential incentive.

10. The electronic device of claim 1, wherein the at least one processor further configures the electronic device to:
in response to detecting the trigger, transmit, to an incentive tracking repository, a request for incentive data of possible incentives that are applicable to the intended purchase transaction, the possible incentives including a first potential incentive that is valid for an associated first incentive time period and has the first incentive threshold spend amount;
receive, in response to the request for the incentive data, the incentive data from the incentive tracking repository; and
identify, from the incentive data, the first potential incentive that is potentially available for the intended purchase transaction.

11. A method comprising:
detecting, via at least one processor of an electronic device, a trigger indicative of an intended purchase transaction having a transaction total spend amount;
identifying a first potential incentive applicable to the intended purchase transaction and having a first incentive threshold spend amount to trigger receipt of a corresponding incentive; and
in response to identifying the first potential incentive:
presenting a first incentive notification on a display, the first incentive notification indicating that the first potential incentive is potentially available if the transaction total spend amount of the intended purchase transaction meets or exceeds the first incentive threshold spend amount; and
activating and presenting at least one first user-selectable option on the display that facilitates electronic notification of and coordination with at least one potential second purchaser associated with a communicatively connected second electronic device to incorporate combined purchasing of additional items by the at least one potential second purchaser within the intended purchase transaction.

12. The method of claim 11, further comprising:
presenting a first graphical user interface (GUI) on the display, the first GUI including the first incentive notification and a second user-selectable option to continue shopping for at least one additional second item in order to qualify for the first potential incentive; and
in response to detecting selection of the second user-selectable option:
enabling continuation of the intended purchase transaction to include addition of the at least one additional second item;
updating the transaction total spend amount to include a cost of the at least one additional second item; and
generating an alert identifying when the updated transaction total spend amount reaches the first incentive threshold spend amount.

13. The method of claim 11, further comprising:
detecting selection of the at least one first user-selectable option;
in response to detecting selection of the at least one first user-selectable option, presenting a second GUI on the display, the second GUI including a third user-selectable option to select the at least one potential second purchaser from a first set of potential second purchasers to receive a purchase coordination notification; and
in response to detecting selection of the at least one potential second purchaser followed by the third user-selectable option, transmitting the purchase coordination notification to the second electronic device associated with the at least one potential second purchaser, the purchase coordination notification informing the at least one potential second purchaser that the first potential incentive is potentially available with collaborative purchase of at least one additional second item.

14. The method of claim 13, further comprising:
receiving, from the second electronic device, a response to the purchase coordination notification, the response including a request to purchase at least one additional second item having a second item purchase amount;
adding the at least one second item to the purchase transaction;
updating the transaction total spend amount by summing a first item purchase amount and the second item purchase amount;
determining if the transaction total spend amount is greater than the first incentive threshold spend amount; and
in response to determining that the transaction total spend amount is greater than the first incentive threshold spend amount:
presenting a message indicating that the first incentive threshold spend amount has been reached and that the first incentive is now available; and
enabling completion of the purchase transaction using the first incentive to purchase the at least one first item and the at least one additional second item.

15. The method of claim 13, further comprising:
presenting at least one payment option from among:
a first user-selectable payment option to initiate processing to complete payment for the combined purchase transaction by a first user of the electronic device; and
a second user-selectable payment option to initiate a split payment processing to enable payment for the at least one first item by the first user of the electronic device and a separate payment for the at least one additional second item by a second user of the second electronic device.

16. The method of claim 13, further comprising:
presenting at least one shipping option from among:
a first user-selectable shipping option that provides a first address as a common shipping destination for the combined purchase transaction; and
a second user-selectable shipping option that provides a first address as a first shipping destination for the at least one first item and at least one second address as a second shipping destination for the at least one additional second item.

17. The method of claim 11, further comprising:
determining that the transaction total spend amount is less than the first incentive threshold spend amount;
determining a difference between the first incentive threshold spend amount and the transaction total spend amount; and
outputting the difference along with the first incentive notification of the first potential incentive to alert a user of an additional spend amount required to obtain the first potential incentive.

18. The method of claim 11, further comprising:
identifying an expiration time of the first potential incentive;
determining a remaining time that the first potential incentive is valid; and
presenting the remaining time that the first potential incentive is valid on the display.

19. The method of claim 11, further comprising:
detecting addition of at least one first item to an online shopping cart; and
in response to detecting an addition of each subsequent item to the online shopping cart:
updating both the transaction total spend amount and a difference between the first incentive threshold spend amount and the transaction total spend amount; and
presenting an updated difference on the display of the electronic device along with a remaining time to receive the first potential incentive.

20. A computer program product comprising:
a computer readable storage device having stored thereon program code which, when executed by at least one processor of an electronic device having a display, a communication system, and a memory, enables the electronic device to complete the functionality of:
detecting a trigger indicative of an intended purchase transaction having a transaction total spend amount;
identifying a first potential incentive applicable to the intended purchase transaction and having a first incentive threshold spend amount to trigger receipt of a corresponding incentive; and
in response to identifying the first potential incentive:
presenting a first incentive notification on a display, the first incentive notification indicating that the first potential incentive is potentially available if the transaction total spend amount of the intended purchase transaction meets or exceeds the first incentive threshold spend amount; and
activating and presenting at least one first user-selectable option on the display that facilitates electronic notification of and coordination with at least one potential second purchaser associated with a communicatively connected second electronic device to incorporate combined purchasing of additional items by the at least one potential second purchaser within the intended purchase transaction.
